(19) United States
(12) Patent Application Publication
(10) Pub. No.: US 2006/0261556 A1
(43) Pub. Date: Nov. 23, 2006

(54) Method and device for playing a game using characteristics of game pieces

(76) Inventor: Richard Darling, Egg Harbor City, NJ (US)

Correspondence Address: MATHEWS, SHEPHERD, MCKAY, & BRUNEAU, P.A., 29 THANT ROAD, SUITE 201, PRINCETON, NJ, 08540, US

(21) Appl. No.: 11/131,567

(22) Filed: May 18, 2005

(51) Int. Cl. A63F 3/00; A63F 1/00; G06F 19/00

(52) U.S. Cl. 273/273; 273/292; 463/11

(57) ABSTRACT

The present invention relates to a method of playing a game in which a value of a sequence of game pieces having a certain characteristic is determined. For example, the sequence of game pieces can be the number of game pieces having a certain characteristic such as odd or even, black or red. The value of the sequence of game pieces can be determined randomly such as by rolling a die or spinning a spinner. The game pieces are dealt to a player to the value of the sequence of game pieces. If each of the game pieces dealt to a player has the certain characteristic, the player wins. A payout can be paid according to the difficulty in obtaining the number of game pieces having the certain characteristic.

### BACKGROUND OF THE INVENTION

1. Field of the Invention

The invention relates to games, such as a game in which a value of a sequence of game pieces having a certain characteristic is matched against a previous determination of the sequence value.

2. Description of Related Art

Variations in card games using card point values are known. In games such as black jack, a point value of cards is each player's hand is added together to determine the value of the hand after the player had the opportunity to be dealt additional cards. Different hands are compared to determine the winning hand, such as comparing the hand against the dealer hand.

U.S. Pat. No. 5,632,486 describes a method of playing a card game using a card number subtracting technique in which cards of the playing deck are assigned numerical point values. Eights, nines and tens are removed from the standard deck to establish a deck of forty cards. Each numbered card is assigned its point value. Each ace is assigned a value of one. Each face card is assigned a value of zero. Two cards are initially dealt to each player with each player having the option of receiving a third card. If a third card is dealt, one of the cards is discarded. The hands are compared to determine a winning hand as the hand in which the point value difference between the two cards in the hand is closest to zero.

U.S. Pat. No. 5,713,573 discloses a wagering card game permitting players to play against a dealer or the “house” and not against other players. Six standard decks of playing cards, from which all face cards have been removed, are combined. Each of the numbered cards has a number value equal to its number, and aces have a number value of 11. Each player places a wager as to whether a three-card game hand to be dealt to him or her will be odd or even. If a player's odd/even wager matches the sum of the number values of the three cards dealt to that player, then the player wins the wager. Preferably, a single card is dealt face down to the dealer and in addition to an odd/even wager as to the player's own game hand, the player is permitted to place one or more other wagers as to a characteristic of the face down card. Further, each player is permitted to place additional wagers as to another characteristic of the cards in the player's own game hand. Variations of the type of game hand dealt are also possible.

It is desirable to provide a card game using a simple concept which is easy to play and provides increased player's interest.

### SUMMARY OF THE INVENTION

The present invention relates to a method of playing a game in which a value of a sequence of game pieces having a certain characteristic is determined. For example, the sequence of game pieces can be the number of game pieces having a certain characteristic such as odd or even, black or red. The value of the sequence of game pieces can be determined randomly such as by rolling a die or spinning a spinner. For example, the value of the sequence of game pieces can be between one and six. The game pieces are dealt to a player to the value of the sequence of game pieces. If each of the game pieces dealt to the player has the certain characteristic, the player wins. A payout can be paid according to the difficulty in obtaining the number of game pieces having the certain characteristic.

The invention will be more fully described by reference to the following drawings.

### BRIEF DESCRIPTION OF THE DRAWINGS

FIG. 1 is a flow diagram of a method of playing a game.

FIG. 2 is a schematic diagram of a betting board which can be used with the game.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

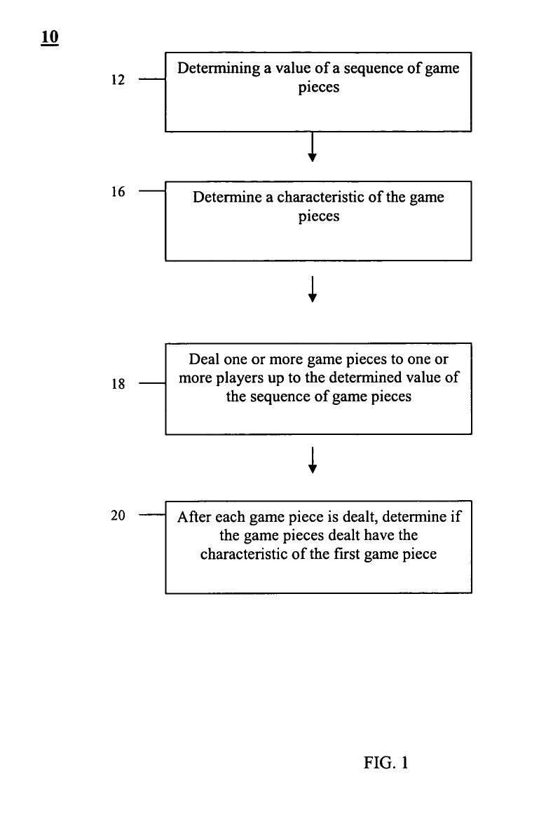

FIG. 1 is a flow diagram of a method of playing a card game using characteristics of game pieces 10. In block 12, a value of a sequence of game pieces having a certain characteristic is determined. In one embodiment, one or more conventional decks of 52 cards can be used as game pieces. In an alternate embodiment, the game pieces can be a deck of a predetermined number of cards having a certain characteristic, for example, ten red cards and ten black cards or twenty red cards and twenty black cards. In an alternate embodiment, the game pieces can be a deck of cards having an odd or even characteristic, for example, five odd cards and five even cards, or ten odd cards and ten even cards. The value of numeric cards 2 through 10 can be assigned the same numeric point values shown on the face of the card, i.e., a two of any suit is assigned the point value of 2, a three of any suit is assigned the point value of 3, a four of any suit is assigned the point value of 4, a five of any suit is assigned the point value of 5, a six of any suit is assigned the point value of 6, a seven of any suit is assigned the point value of 7, an eight of any suit is assigned the point value of 8, and a nine of any suit is assigned the point value of 9 and a ten of any suit is assigned the point value of 10. An ace of any suit is assigned the value of 1. Each of the face cards of any suit, such as Jack, Queen and King, is assigned the point value of 10. Alternatively, each of the face cards of any suit can be assigned a different point value, such as each Jack being assigned a point value of 11, each Queen being assigned a point value of 12 and each King being assigned a point value of 13.

In an alternate embodiment, Mah Jongg tiles can be used as game pieces. A number of Mah Jongg tiles are dealt to a player. Each of the Mah Jongg tiles is assigned the same point value as the values on the face of the Mah Jongg tiles.

Alternatively, the game pieces can be one or more dominoes or die. The assigned point values of the game pieces are determined by the corresponding numbers of dots or numbers on the game pieces. In one embodiment, a predetermined number of dice are rolled for each player. For example, the number of dice can be two through six die.

The value of the sequence of game pieces can be determined randomly. For example, the value can be a number between one and six which is determined from a dice, spinner or cards having a value between one and six. Alternatively, the value of the sequence of game pieces has a larger range, such as within the range of one to ten. The value of the sequence of game pieces determines the number of game pieces in a row which are needed to win the game. For example, if the value of the sequence of game pieces is three, the player needs to be dealt three game pieces in a row having a certain characteristic.

In block 16, a certain characteristic of the game pieces is determined. In one embodiment, a first game piece is dealt to one or more players. For example, the characteristic of the first game piece can be that the game piece is either black or red. Alternatively, the characteristic of the first game piece can be that the game piece is odd or even. It will be appreciated that other characteristics, i.e., different colors or shapes on the game pieces, can be used with the teachings of the present invention. In this embodiment, the characteristic of the first game piece is used to determine the certain characteristic for subsequent game pieces. In an alternate embodiment, the certain characteristic of the game pieces can be determined randomly using a spinner or preselected by a player or dealer. In an alternate embodiment, the game piece can include the certain characteristics of the game pieces. For example, the game piece can indicate 2, 3 or 4 matches are the certain characteristic of the game pieces.

In block 18, game pieces are dealt to the one or more players to the determined value of the sequence of the game pieces. In block 20, after each game piece is dealt, it is determined if the game piece has the same characteristic of the determined certain characteristic. If each of the subsequent game pieces up to the value of the sequence of the game pieces has the certain characteristic, such as the characteristic of the first game piece, the player dealt the one or more game pieces is a winner. For example, if the value of the sequence of game pieces is three and the first game piece dealt is red, in order to win, the player would need to be dealt three subsequent game pieces which are red.

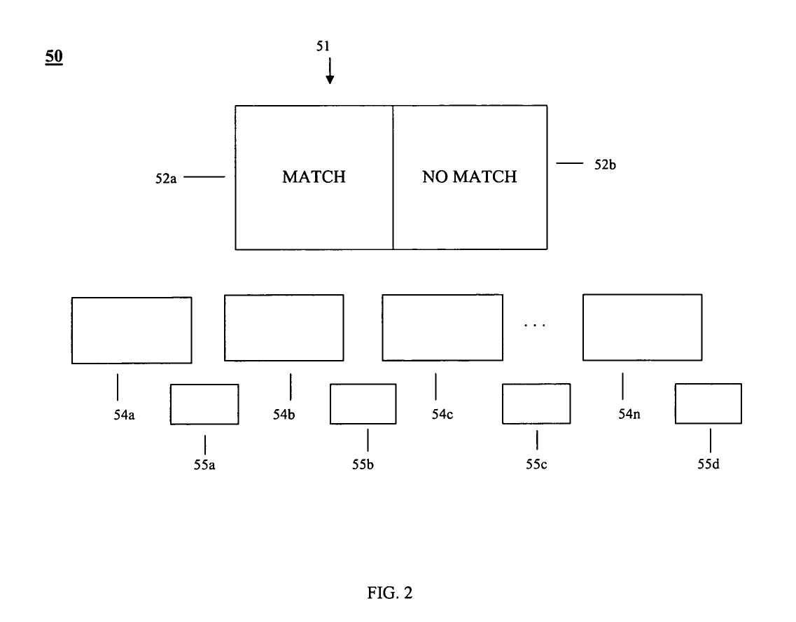

Betting can take place on the guess of a match of the value of the sequence of game pieces having a certain characteristic being handed out to a player. In one embodiment, device for playing a game 50 includes betting board 51, as shown in FIG. 2. Betting board 51 can be a game table. Betting board 51 is partitioned into portions 52a-52d. Each portion 52a-52b corresponds to a guess of a match of the value of the sequence of game pieces having a certain characteristic. For example portion 52a corresponds to a guess of a match of the value of the sequence of game pieces having a certain characteristic. Portion 52b corresponds to a guess of a no match of the value of the sequence of game pieces having a certain characteristic.

A player places a wager of any amount on one or more of portions 52a-52b. The value of the sequence of game pieces is selected by the dealer or a player or preselected by the house. The certain characteristic of the game piece is determined. For example, a first game piece is dealt to one or more players at dealer stations 54a-54n to determine the certain characteristic of the game pieces. Subsequent game pieces are dealt to one or more players at dealer stations 54a-54n up to the value of the sequence of game pieces. A player wins a bet if a bet was placed on a portion 52a-52b corresponding to the guess of a match of the value of the sequence of game pieces having a certain characteristic and the player matches of the value of the sequence of game pieces having a certain characteristic or if a guess of no match of the value of the sequence of game pieces having a certain characteristic and the player does not match of the value of the sequence of game pieces having a certain characteristic.

A winning matched guessed value earns the player a predetermined payout. For example, the payout can be equal to the amount bet or can be greater than the amount bet, such as paying out 3 to 1 odds. In one embodiment, the payout is based at least in part on the probability of the value of the sequence of game pieces. In one embodiment, the odds of winning the game may be made more in favor of the house. For example, a winning player will be paid less than the true odds of the bet in order to allow the house or casino to profit from hosting the game.

In another embodiment, the house can take a commission on all winning players, for example, 5% of the winnings. In another embodiment, a certain total point value will not payout the bet even if a number value of a remainder is matched.

In one embodiment, each player is dealt the game pieces. Alternatively, only one hand of game pieces is dealt and one or more players can bet against the dealt hand of game pieces.

In one embodiment, the game is played in a casino. Alternatively the game can be played on a video screen or over the Internet.

In another embodiment, a bonus wager is placed at portion 55a-55d. Before the game pieces are dealt to a player, one or more game pieces are placed aside portion 55a-55d as bonus game pieces. After the method of playing a card game using characteristics of game pieces 10 is played, the one or more bonus game pieces aside bonus portion 55a-55d are revealed. A player wins if the bonus game pieces match the certain characteristic described above. For example, if the certain characteristic is described is odd, the player will win if the one or more bonus game pieces are odd. Alternatively, a player wins if the bonus game pieces have predetermined characteristics depending on the number of bonus game pieces used. For example, for two bonus game pieces, the predetermined characteristic can be two of a kind or same suit. For three bonus game pieces the predetermined characteristic can be three of a kind, same suit, or straight. For four bonus game pieces, the predetermined characteristic can be two pair, same suit or straight. It will be appreciated that various predetermined characteristic can be used in accordance with the teachings of the present invention. The bonus can also be paid out in a progressive manner in which bonus bets which are not paid out are accumulated and a subsequent player having a winning bonus bet collects the accumulated bonus bets.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method of playing a game comprising the steps of:
a. determining a value of a sequence of game pieces having a certain characteristic;
b. determining said certain characteristic;
c. dealing one or more game pieces to one or more players to said value of said sequence of game pieces; and
d. determining if each of said game pieces dealt to said one or more players have said certain characteristic.

2. The method of claim 1 wherein in step b. said certain characteristic is determined from a first game piece dealt to a player before step c.

3. The method of claim 1 wherein in step b. said certain characteristic is determined randomly.

4. The method of claim 1 wherein in step b. said certain characteristic is selected by one of said one or more players.

5. The method of claim 1 wherein in step b. said certain characteristic is determined by a dealer.

6. The method of claim 1 wherein the game pieces are one or more cards of a deck of 52 cards, each type of card is assigned a point value and said certain characteristic is each of said one or more game pieces being odd or even.

7. The method of claim 6 wherein the assigned point value of each face card in the deck is a value of 10.

8. The method of claim 6 wherein the assigned point value of each face card in the deck is a value of 11 for a Jack, a value of 12 for a Queen and a value of 13 for a King.

9. The method of claim 6 wherein the assigned point value of each Ace in the deck is 1.

10. The method of claim 1 wherein said one or more cards are one or more cards having a value of 2 through 10 in the deck, the assigned point value of said one or more cards is a respective value of the numeric cards, said assigned point value being determined as odd or even.

11. The method of claim 1 wherein the game pieces are one or more die, each face of the die is assigned a point value equaling dots on said one or more die, the total point value being a total of the assigned point values for an upward face of each of the one or more die, the total point value being determined as odd or even.

12. The method of claim 1 wherein the game pieces are one or more Mah Jongg tiles, each type of Mah Jongg tile is assigned a point value being determined from symbols on the Mah Jongg tile, the total point value being a total of the assigned point values, the total point value being determined as odd or even.

13. The method of claim 1 wherein the game pieces are one or more dominos, each face of the dominos is assigned a point value equaling dots on said one or more dominoes, the total point value being a total of the assigned point values for an upward face of each of the one or more dominos, said total point value being determined as odd or even.

14. The method of claim 1 wherein said game pieces are ten cards, five of said ten cards having an odd point value and five of said ten cards having an even point value, said certain characteristic is each of said one or more game pieces being odd or even.

15. The method of claim 1 wherein the game pieces are one or more cards of a deck of 52 cards, each card is either red or black, said certain characteristic is each of said one or more game pieces being red or black.

16. The method of claim 1 wherein the game is played in a casino.

17. The method of claim 1 wherein the game is played on a video machine.

18. The method of claim 1 wherein the game is played over the Internet.

19. The method of claim 1 further comprising the step of:
placing one or more bets on a guess of the value of a sequence of game pieces having a certain characteristic and a payout is paid if the guess of the value of the sequence of game pieces having a certain characteristic is matched.

20. The method of claim 19 wherein the payout is based at least in part on a probability of obtaining the value of a sequence of game pieces having a certain characteristic.

21. The method of claim 20 wherein the payout is equal to an amount of the bet.

22. The method of claim 20 wherein the payout is greater than an amount of the bet.

23. The method of claim 1 further comprising the steps of:
determining before step a., one or more bonus game pieces, and determining after step d. if said one or more bonus game pieces match said certain characteristic.

24. The method of claim 23 further comprising the steps of:
placing a bonus wager; and
paying a payout if said one or more bonus game pieces are determined to match said certain characteristics.

25. The method of claim 1 further comprising the steps of:
determining before step a., one or more game pieces, and
determining after step d. if said one or more bonus game pieces match said a predetermined characteristic.

26. The method of claim 25 further comprising the steps of:
placing a bonus wager; and
paying a payout if said one or more bonus game pieces are determined to match said predetermined characteristic.

27. A device for providing a card game comprising:
a playing area defined by one or more betting locations configured to receive one or more bets requiring a guess of a match or no match of said value of a sequence of game pieces having a certain characteristic;
said match or no match of said value of a sequence of game pieces having a certain characteristic being determined from each of said game pieces having a certain characteristic; and
a dealer station having one or more locations configured to receive game pieces.

28. The device of claim 27 wherein the betting locations and said dealer station are located on a gaming table.

29. The device of claim 27 wherein the game is played in a casino.

30. The device of claim 27 wherein the game is played on a video machine.

31. The device of claim 27 wherein the game is played over the Internet.
